(19) United States
(12) Patent Application Publication
(10) Pub. No.: US 2006/0083261 A1
(43) Pub. Date: Apr. 20, 2006

(54) Data transmission apparatus, data transmission method, data transmission program, and recording medium

(76) Inventors: Yasuhiro Maeda, Tokyo (JP); Kazuhiro Okanoue, Tokyo (JP); Toshikazu Maruyama, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/251,833

(22) Filed: Oct. 18, 2005

(30) Foreign Application Priority Data
Oct. 19, 2004 (JP) 2004-304412

(51) Int. Cl. H04J 3/22

(52) U.S. Cl. 370/465; 370/252

(57) ABSTRACT

Establishment of a connection between a wireless terminal and a destination terminal for data transmission. The wireless terminal is connectable to at least two communication networks each of which is connected to an internet. The destination terminal is connected to the internet. First, one of the communication networks is selected at the wireless terminal based on communication quality of the communication networks. Next, a path through the selected communication network is selected at the wireless terminal based on the network address of the destination terminal. And then a connection is established between the wireless terminal and the destination terminal through the selected path.

This application claims priority to prior Japanese patent application JP 2004-304412, the disclosure of which is incorporated herein by reference.

### BACKGROUND OF THE INVENTION

1. Field of the Invention

The present invention relates to a data transmission apparatus, a data transmission method, and a data transmission program for transmitting data to which destination information is added, to an opponent shown by the destination information, and to a recording medium to which the program is recorded, and more particularly, to a dt transmission apparatus, a data transmission method, a data transmission program, and a recording medium for transmitting data by selecting any of a plurality of communication interfaces for connecting to different communication networks, respectively,

2. Description of the Related Art

Recently, communication terminals having a plurality of communication devices for connecting to different communication networks, respectively have become widespread. These communication terminals are, for example, mobile phones corresponding to Local Area Network (Wireless LAN), Wireless LAN terminals capable of corresponding to different communication systems of Wireless LAN, and the like. Further, there exists a communication terminal in which two communication service operators share the same Wireless LAN access point, and the both communication networks can be connected by selectively using device drivers.

These communication terminals can provide users with a more convenient communication environment by making the best use of the advantages of the communication terminals by selectively using communication devices, device drivers, or combinations of them (which are generically called communication interfaces hereinafter) depending on circumstances. For example, high speed and comfortable Wireless LAN is used in the communication areas of Wireless LAN distributed in urban areas and circuit switching networks for mobile phones, which have a wide communication area, are used in suburbs where Wireless LAN cannot be used.

Incidentally, communication interfaces must be switched frequently sometimes. This is, for example, a case in which the statuses of radio waves of a plurality of different radio communication devices provided with a communication terminal change as the devices move. When the communication interfaces are switched frequently, switching them by a user not only takes a lot of time and labor but also may cause a problem in that an improper communication interface is selected by a misoperation.

To cope with the above problems, a data transmission apparatus for switching a transmission path for every transmission data has been proposed (for example, Japanese Unexamined Patent Application Publication No. 2004-120195, paragraphs 15 and 16, FIG. 9). This proposal includes a table describing communication quality in correspondence to the paths that can be employed up to respective opponents. Utilization of the table permits to execute a communication by selecting a proper path for each unit of transmission data and using a communication interface corresponding to the proper path.

However, when respective communication interfaces are connected to relatively large networks, the number of paths that can be employed to up respective opponents increases. As a result, since the amount of information described in the table increases, selecting a proper path takes a long time.

Accordingly, an object of the present invention is to provide a data transmission apparatus, a data transmission method, a data transmission program, and a recording medium which can transmit data by effectively selecting a proper communication interface from a plurality of communication interfaces.

### SUMMARY OF THE INVENTION

In a first aspect of the invention, a data transmission apparatus includes (a) a plurality of sets of communication network connection means for connecting to different communication networks, respectively, (b) communication quality information store means for storing communication quality information as information as to the communication quality of the communication networks, to which the communication network connection means are connected, by corresponding the communication quality information to each of the plurality of sets of communication network connection means, (c) a plurality of address path correspondence tables each disposed to each of the transmission network connection means to store the addresses of respective opponents and path information as information showing paths to the addresses through the communication networks, to which the transmission network connection means are connected, by corresponding the addresses to the path information, (d) to-be-used communication network connection means selection means for selecting communication network connection means which is used to transmit data as the object of transmission based on the communication quality information stored in the communication quality information store means, (e) address path correspondence table discrimination means for discriminating an address path correspondence table corresponding to the communication network connection means selected by the to-be-used communication network connection means selection means from the plurality of address path correspondence tables, (f) path information acquisition mean for acquiring corresponding path information by searching the destination address of the data by the address path correspondence table discriminated by the address path correspondence table determination means, and (g) data transmission means for transmitting the data through the path shown by the path information acquired by the path information acquisition means.

More specifically, the first aspect of the invention has the plurality of sets of communication network connection means for connecting to the different communication networks, respectively and the communication quality information store means for storing the communication quality information as the information as to the communication quality of the communication networks to which the respective sets of the communication network connection means are connected. Further, the first aspect of the invention has the plurality of address path correspondence tables each disposed to each of the transmission network connection means to store the addresses of the respective opponents and the path information as the information showing the paths to the addresses through the communication networks, to which the transmission network connection means are connected, by corresponding the addresses to the path information. A communication network connection means, which is used to the transmission of the data as the object of transmission, is selected based on the communication quality information stored in the communication quality information store means, and a corresponding address path correspondence table is discriminated. Then, the destination address of the data is searched from the discriminated address path correspondence table, and the data is transmitted through the path shown by the corresponding path information. With this operation, it is possible to select a proper communication network to each set of data as the object of transmission and to transmit the data using a communication network connection means connecting to the communication network. Further, since the path correspondence table is provided with each communication network connection means, a path can be selected by two steps of selecting a communication network connection means based on communication quality and selecting a path based on destination information, thereby the path can be more effectively selected.

In a second aspect of the invention, a method of establishing connection between a wireless terminal and a destination terminal, the wireless terminal being connectable to at least two communication networks each of which is connected to an internet, the destination terminal being connected to the internet, includes the steps of; (a) selecting one of the communication networks at the wireless terminal based on communication quality of the communication networks; (b) selecting a path through the communication network and the internet selected at the step (a) at the wireless terminal based on the network address of the destination terminal; and (c) establishing a connection between the wireless terminal and the destination terminal through the path selected at the step (b).

In a third aspect of the invention, a data transmission method includes (a) a requested quality discrimination step of discriminating requested quality as communication quality requested to the transmission of data intended to be transmitted using a plurality of sets of communication network connection means for connecting to different communication networks, respectively, (b) a communication network connection means selection step of discriminating communication quality information, which is most suitable to the requested quality discriminated at the requested quality discrimination step, as information as to the communication quality of the communication networks to which the plurality of sets of communication network connection means are connected from communication quality information store means in which the communication quality information is stored in correspondence to each of the respective sets of communication network connection means and selecting a corresponding communication network connection means as communication network connection means to be used to the transmission of the data, (c) an address path correspondence table discrimination step of discriminating an address path correspondence table, which corresponds to the communication network connection means selected at the communication network connection means selection step from a plurality of address path correspondence tables which are disposed to the respective sets of the communication network connection means and in which opponent addresses and path information as information showing paths up to the addresses through communication networks, to which the communication network connection means are connected, are stored in correspondence to each other, (d) a path information acquisition step of searching the destination address of the data as an object of transmission in the address path correspondence table discriminated at the address path correspondence table discrimination step and acquiring corresponding path information, and (e) data transmission step of transmitting the data through the path shown by the path information acquired at the path information acquisition step.

More specifically, in the third aspect of the invention, first, requested quality as communication quality requested to transmission and added to data as an object of transmission is discriminated. Then, a corresponding communication network connection means is selected by discriminating the communication quality information most suitable to the discriminated requested quality from the communication quality information store means for storing the communication quality information as the information of the communication network to which the plurality of sets of communication network connection means connect.

An address path correspondence table, which corresponds to the selected communication network connection means, is discriminated from the plurality of address path correspondence tables which are disposed to the respective sets of the communication network connection means and in which the opponent addresses and the path information as the information showing the paths up to the addresses through communication networks, to which the communication network connection means are connected, are stored in correspondence to each other. Then, the destination address of the data as the object of transmission is searched in the discriminated address path correspondence table, and the data is transmitted through the path shown by the corresponding path information. With this operation, each set of data as the object of transmission can be transmitted using a proper communication network connection means. Further, since a path can be selected by two steps of selecting a communication network connection means based on communication quality and selecting a path based on destination information, the path can be more effectively selected.

In a fourth aspect of the invention, a computer of a data transmission apparatus is caused to execute (a) requested quality discrimination processing for discriminating requested quality as communication quality requested to the transmission of data which the data transmission apparatus intends to transmit using a plurality of sets of communication network connection means for connecting to different communication networks, respectively, (b) communication network connection means selection processing for discriminating communication quality information, which is most suitable to the requested quality discriminated by the requested quality discrimination processing, as information as to the communication quality of the communication networks to which the plurality of sets of communication network connection means are connected from communication quality information store means in which the communication quality information is stored in correspondence to each of the respective sets of the communication network connection means and selecting a corresponding communication network connection means as communication network connection means to be used to the transmission of the data, (c) address path correspondence table discrimination processing for discriminating an address path correspondence table, which corresponds to the communication network connection means selected by the communication network connection means selection processing from a plurality of address path correspondence tables which are disposed to the respective sets of the communication network connection means and in which opponent addresses and path information as information showing paths up to the addresses through communication networks to which the communication network connection means are connected, (d) path information acquisition processing for searching the destination address of the data as an object of transmission in the address path correspondence table discriminated by the address path correspondence table discrimination processing and acquiring corresponding path information, and (e) data transmission processing for transmitting the data through the path shown by the path information acquired by the path information acquisition processing.

More specifically, in the fourth aspect of the invention, first, requested quality as communication quality requested to transmission and added to data as an object of transmission is discriminated. Then, a corresponding communication network connection means is selected by discriminating the communication quality information most suitable to the discriminated requested quality from the communication quality information store means for storing the communication quality information as the information of the communication network to which the plurality of sets of communication network connection means connect.

An address path correspondence table, which corresponds to the selected communication network connection means, is discriminated from the plurality of address path correspondence tables which are disposed to the respective sets of the communication network connection means and in which the opponent addresses and the path information up to the addresses through communication networks, to which the communication network connection means are connected, are stored in correspondence to each other. Then, the destination address of the data as the object of transmission is searched in the discriminated address path correspondence table, and the data is transmitted through the path shown by the corresponding path information. With this operation, each set of data as the object of transmission can be transmitted using a proper communication network connection means. Further, since a path can be selected by two steps of selecting a communication network connection means based on communication quality and selecting a path based on destination information, the path can be more effectively selected.

In a fifth aspect of the invention, a machine language readable recording medium records a program for executing (a) a requested quality discrimination procedure for discriminating requested quality as communication quality requested to the transmission of data intended to be transmitted using a plurality of sets of communication network connection means for connecting to different communication networks, respectively, (b) a communication network connection means selection procedure for discriminating communication quality information, which is most suitable to the requested quality discriminated by the requested quality discrimination procedure, as information as to the communication quality of the communication networks to which the plurality of sets of communication network connection means are connected from communication quality information store means in which the communication quality information is stored in correspondence to each of the respective sets of communication network connection means and selecting a corresponding communication network connection means as communication network connection means to be used to the transmission of the data, (c) an address path correspondence table discrimination procedure for discriminating an address path correspondence table, which corresponds to the communication network connection means selected by the communication network connection means selection procedure from a plurality of address path correspondence tables which are disposed to the respective sets of the communication network connection means and in which opponent addresses and path information as information showing paths up to the addresses through communication networks to which the communication network connection means are connected, (d) a path information acquisition procedure for searching the destination address of the data as an object of transmission in the address path correspondence table discriminated by the address path correspondence table discrimination procedure and acquiring corresponding path information, and (e) a data transmission procedure for transmitting the data through the path shown by the path information acquired by the path information acquisition procedure.

More specifically, in the fifth aspect of the invention, the machine language readable recording medium stores the program for executing the procedures similar to the respective processings executed by the fourth aspect of the invention. Accordingly, even a general-purpose data transmission apparatus can use a proper communication network connection means for each set of data as the object of transmission as well as transmit the data by effectively selecting a path.

As described above, in the present invention, a communication network connection means suitable to data as the object of transmission is selected to each set of data formed the plurality of sets of the communication network connection means. Further, the address path correspondence table, which corresponds to the selected communication network connection means, is discriminated from the plurality of address path correspondence tables which are disposed to the respective sets of the communication network connection means and in which the opponent addresses and the path information up to the addresses through communication networks, to which the communication network connection means are connected, are stored in correspondence to each other. Then, the path information is acquired making use of the discriminated address path correspondence table, and data is transmitted. As a result, since a proper communication network connection means is selected to each set of data and an address path correspondence table, which corresponds only to the communication network connection means, is used, data can be transmitted by effectively selecting a proper path.

### BRIEF DESCRIPTION OF THE DRAWINGS

FIG. 1 is a system configurational view schematically showing a communication system using a mobile phone as a data transmission apparatus of an embodiment of the present invention;

FIG. 2 is a configurational view showing an arrangement of the mobile phone of the embodiment;

FIG. 3 is an explanatory view schematically showing an arrangement of first to fourth communication interface portions of the embodiment,

FIG. 4 is an explanatory view showing an arrangement of an IP protocol processing unit of the embodiment;

FIG. 5 is a configurational view showing an arrangement of a path controller of the embodiment;

FIG. 6 is a configurational view showing an arrangement of a transmission data analysis processing unit of the embodiment;

FIG. 7 is an explanatory view showing an arrangement of transmission data created by a transmission data creation processing unit of the embodiment;

FIG. 8 is an explanatory view showing the contents of a destination information vs. physical interface correspondence table;

FIG. 9 is a flowchart showing a flow of path control table determination processing executed by a path control table determination processing unit of the embodiment;

FIG. 10 is an explanatory view showing the contents of a communication interface portion information database of the embodiment;

FIG. 11 is an explanatory view showing the contents of a priority information table of the embodiment;

FIG. 12 is an explanatory view showing the contents of a table showing a communication interface portion vs. path control table designation information of the embodiment;

FIG. 13 is an explanatory view showing an arrangement of first data received by a TCP/UDP protocol processing unit of the embodiment from the transmission data analysis processing unit;

FIG. 14 is an explanatory view showing an arrangement of second data received by an IP protocol processing unit of the embodiment from the TCP/UDP protocol processing unit;

FIG. 15 is an explanatory view showing an arrangement of an IP packet created by an IP packet creation/transmission processing unit;

FIG. 16 is a flowchart showing a flow of path control table determination processing executed by the IP packet creation/transmission processing unit of the embodiment;

FIG. 17 is an explanatory view showing a part of the contents of a third path control table of the embodiment,

FIG. 18 is an explanatory view showing a part of the contents of a fourth path control table of the embodiment;

FIG. 19 is a flowchart showing a flow of transfer destination determination processing executed by the IP packet creation/transmission processing unit of the embodiment;

FIG. 20 is an explanatory view schematically showing a first example of the other patterns of a plurality of communication interface portions of the embodiment;

FIG. 21 is an explanatory view schematically showing a second example of the other patterns of the plurality of communication interface portions of the embodiment;

FIG. 22 is an explanatory view schematically showing a third example of the other patterns of the plurality of communication interface portions of the embodiment;

FIG. 23 is a configurational view showing an arrangement of a mobile phone of a modification of the present invention;

FIG. 24 is a configurational view showing an arrangement of a transmission data analysis processing unit of the modification;

FIG. 25 is en explanatory view showing the contents of a destination information vs. priority information correspondence table of the modification;

FIG. 26 is a configurational view showing an arrangement of a path controller of the modification; and

FIG. 27 is an explanatory view showing the contents of a designated information cache table of the modification.

### DESCRIPTION OF THE PREFERRED EMBODIMENTS

The present invention will be explained below as to an embodiment.

### Embodiment

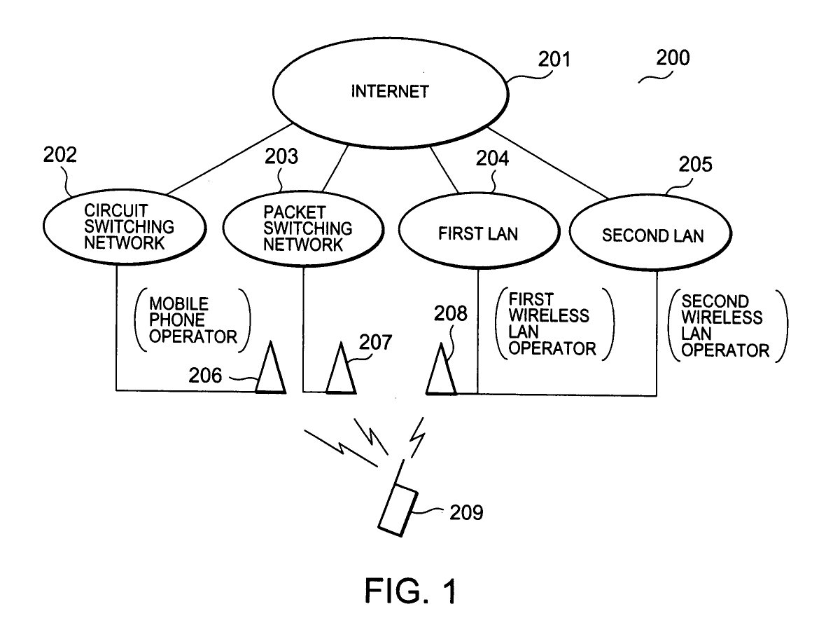

FIG. 1 is a view schematically showing a communication system using a mobile phone as a data transmission apparatus of an embodiment of the present invention. In the communication system 200, a circuit switching network 202 and a packet switching network 203 constructed by a mobile phone operator, a first Wireless LAN 204 constructed by a first LAN operator, and a second Wireless LAN 205 constructed by a second LAN operator are connected to the Internet 201, respectively. A first Wireless Base Transceiver Station 206 is disposed to the circuit switching network 202, a second Wireless Base Transceiver Station 207 is disposed to the packet switching network 203, and a third Wireless Base Transceiver Station 208 is disposed to the first and second LANs 204 and 205, respectively. A mobile phone 209 as a data transmitter is located in an area in which the respective communication areas of the first to third Wireless Base Transceiver Stations 206, 207, and 208 are located in duplication.

The first and second Wireless Base Transceiver Stations 206 and 207 execute a wireless communication using Wideband—Code Division Multiple Access (W—CBMA). Although the first and second Wireless Base Transceiver Stations 206 and 207 actually share various apes of devices such as a communication circuit and the like, they are logically handled as separate Wireless Base Transceiver Stations because they execute a communication through different channels, respectively. Further, the third Wireless Base Transceiver Station 205 executes a wireless communication through Wireless LAN corresponding to both IEEE (The Institute of Electrical and Electronics Engineers, Inc.) 802.11b and IEEE 802.11g. The mobile phone 209 includes a plurality of different communication circuits corresponding to these communication systems, respectively and can communicates with opponents corresponding to the first to third Wireless Base Transceiver Stations 206, 207, and 208, respectively.

Further, a user of the mobile phone 209 joins the communication services provided by the mobile phone operator and the first and second Wireless LAN operators described above. Accordingly, device drivers, which are necessary to connect the mobile phone 209 to the circuit switching network 202, the packet switching network 203, and the first and second LANs 204 and 205, are installed to the mobile phone 209, and necessary settings are input to the mobile phone 209. Therefore, the mobile phone 209 can be connected to the circuit switching network 202, the packet switching network 203, and the first and second LANs 204 and 205, respectively.

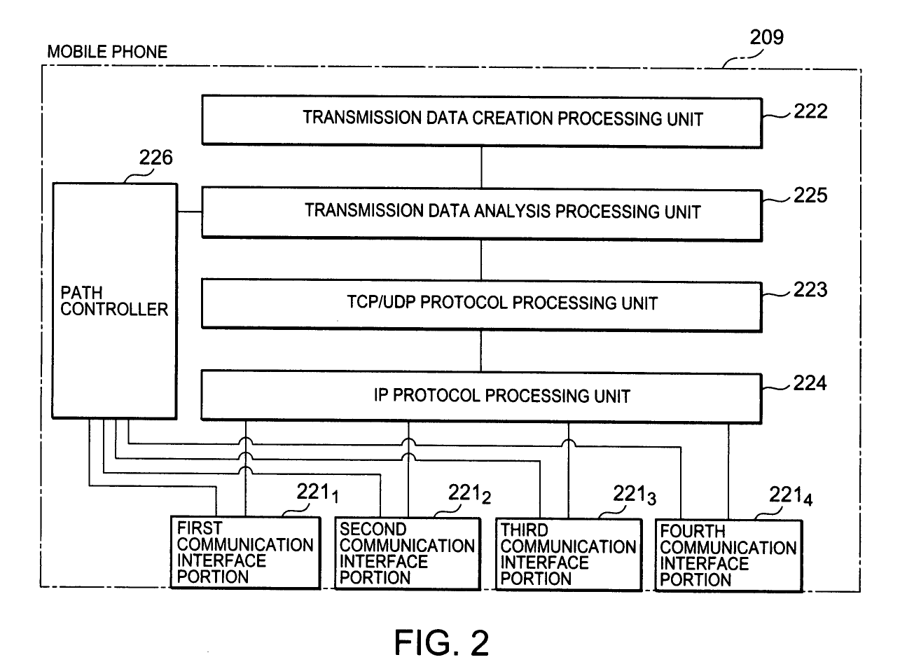

FIG. 2 shows an arrangement of the mobile phone according to the embodiment. The mobile phone 209 includes first to fourth communication interface portions 221₁ to 221₄ to connect to and communicate with communication apparatuses corresponding to the circuit switching network 202, the packet switching network 203, and the first and second LANs 204 and 205 of FIG. 1. The mobile phone 209 includes a transmission data creation processing unit 222 for creating data to be transmitted and a TCP/UDP protocol processing unit 223 for converting the created data into a Transmission Control Protocol (TCP) packet or a User Datagram protocol (UDP) packet The mobile phone 209 includes an IP protocol processing unit 224 for discriminating a next transfer destination by converting a created TCP packet and a created UDP packet into an Internet Protocol (IP) packet as well as executing a communication using a corresponding correspondence interface portion of the first to fourth communication interface portions 221₁ to 221₄. The mobile phone 209 includes a transmission data analysis processing unit 225 interposed between the transmission data creation processing unit 222 and the TCP/UDP protocol processing unit 223, the transmission data analysis processing unit 225 executing analysis processing to select a proper transmission path to transmission data as an object to be transmitted. Further, the mobile phone 209 includes a path controller 226 connected to the transmission data analysis processing unit 225, the IP protocol processing unit 224, and the first to fourth communication interface portions 221₁ to 221₄, respectively to determine a communication interface portion 221 from which transmission data is to be transmitted.

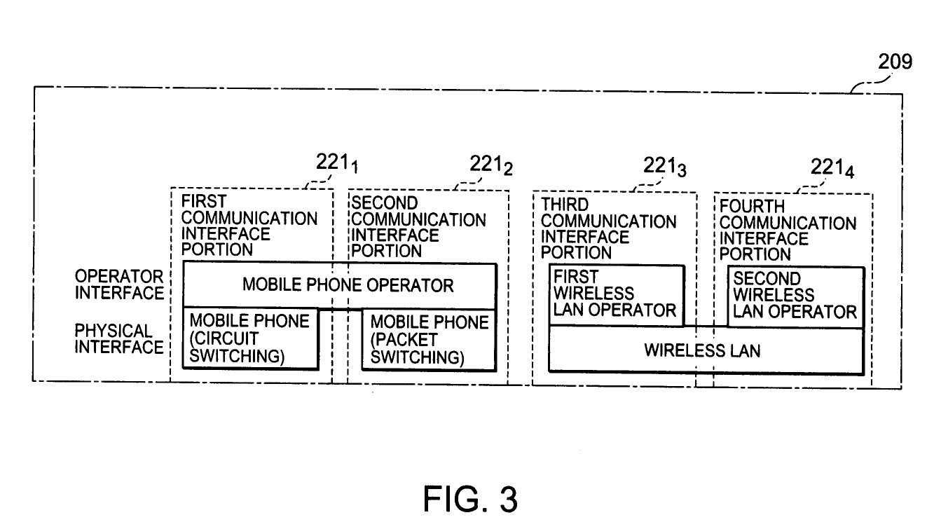

FIG. 3 schematically shows arrangements of the first to fourth communication interface portions as a main portion of the arrangement of the mobile phone. Each of the first to fourth communication interface portions 221₁ to 221₄ is composed of a physical interface as a hardware portion for realizing a predetermined wireless communication such as an antenna, a communication circuit, and the like an operator interface as a software portion for connecting the mobile phone to a predetermined network making use of a wireless communication. The physical interface of the first communication interface portion 221₁ is shown as a “mobile phone (circuit switching)”, which shows that the mobile phone makes a wireless communication with a first Wireless Base Transceiver Station 206₁ connected to the circuit switching network 202 of FIG. 1. The physical interface of the second communication interface portion 221₂ is shown as a “mobile phone (packet switching)”, which shows that the mobile phone makes a wireless communication with a second Wireless Base Transceiver Station 206₂ connected to the packet switching network 203 shown in FIG. 1. The physical interfaces of the third communication interface portion 221₃ and the physical interface of the fourth communication interface portion 221₄ are commonly shown as a “Wireless LAN”, which shows that they make wireless communications with a third Wireless Base Transceiver Station 206₃ connected to the first and second LANs 204 and 205 of FIG. 1.

The physical interface of the first communication interface portion 221₁ and the operator interface of the second communication interface portion 221₂ are commonly shown as a “mobile phone operator”. This shows that there is used a device driver which is necessary to connect to the circuit switching network 202 and the packet switching network 203 distributed or set by the mobile phone operator that provides a communication service by the circuit switching network 202 and the packet switching network 203 of FIG. 1. The operator interface of the third communication interface portion 221₃ is shown as a “First Wireless LAN operator”. This shows that there is used a device driver which is necessary to connect to the first LAN 204 distributed or set by the first Wireless LAN operator that provides a communication service by the first LAN 204 of FIG. 1. The operator interface of the fourth communication interface portion 221₄ is shown as a “second Wireless LAN operator”. This shows that there is used 2 device driver which is necessary to connect to the second LAN 205 distributed or set by the second Wireless LAN operator that provides a communication service by the second LAN 205 of FIG. 1.

More specifically, each of the first to fourth communication interface portions 221₁ to 221₄ is virtually provided by a combination of the physical interface and the operator interface. Accordingly, when a combination of different patterns is further realized or when other types of a physical interface and an operator interface are provided, the number of the communication interface portions 221 is increased. Inversely, a decrease of the number of combined patterns decreases the number of the communication interface portions 221.

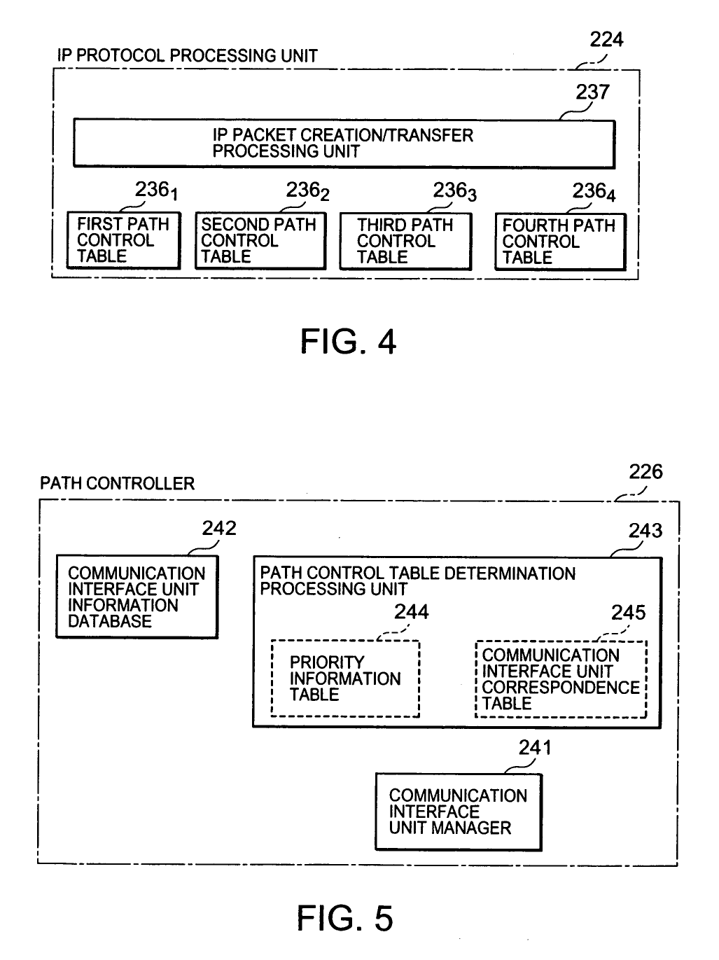

FIG. 4 shows an arrangement of the IP protocol processing unit. The IP protocol processing unit 224 includes first to fourth path control tables 236₁ to 236₄ used to discriminate a next transfer destination in correspondence to the first to fourth communication interface portions 221₁ to 221₄. The IP protocol processing unit 224 includes an IP packet creation/transmission processing unit 237 that discriminates the next transfer destination using a designated one of the path control tables 236 and transmits an IP packet using a corresponding communication interface portion 221. The path controller 226 of FIG. 2 determines a path control table 236 to be used.

FIG. 5 shows an arrangement of the path controller 226. The path controller includes a communication interface portion manager 241 that obtains information of a communication status from the first to fourth communication interface portions 221₁ to 221₄ of FIG. 2 as well as instructs to connect to a corresponding network. Further, the path controller 226 includes a communication interface portion information database 242 for storing information as to the respective communication interface portions 221 of FIG. 2. Further, the path controller 226 includes a path control table determination processing unit 243 which determines, when it is determined that any of the types of the physical interfaces constituting the communication interface portions 221 is suitable for transmission data, a path control table 236 used to discriminate the transfer destination using the communication interface portion information database 242. The path control table determination processing unit 243 includes a priority information table 244 and a communication interface portion correspondence table 245. The priority information table 244 stores information as to priority acting as a basis when the communication interface portion 221 is selected, and the communication interface portion correspondence table 245 corresponds each of the respective communication interface portions 221 to a path control table 236 (FIG. 4) to be used. The transmission data analysis processing unit 225 of FIG. 2 discriminates the type of a physical interface suitable for the transmission data.

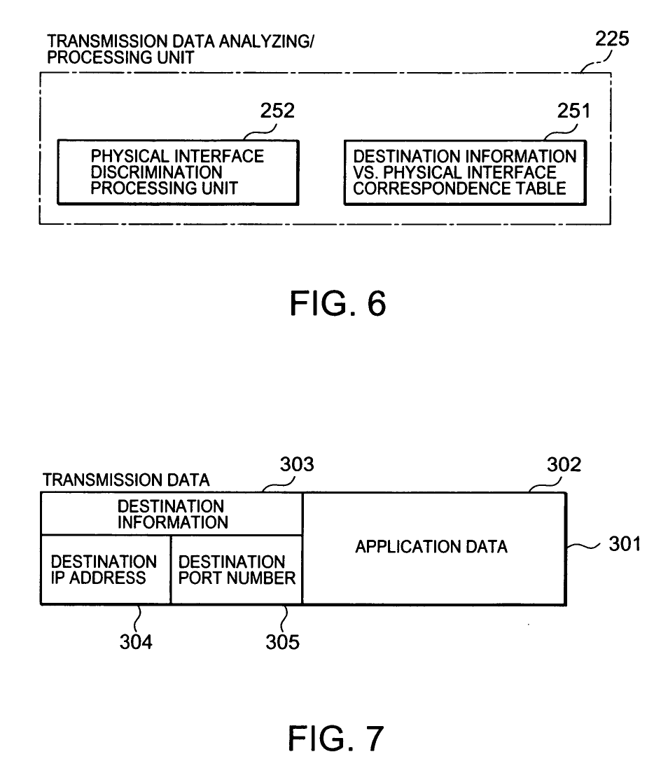

FIG. 6 shows an arrangement of the transmission data analysis processing unit. The transmission data analysis processing unit 225 includes an destination information vs. physical interface correspondence table 251 that corresponds information as to the destination of the transmission data to the types of the physical interfaces. Further, the transmission data analysis processing unit 225 includes a physical interface discrimination processing unit 252 which extracts, when the transmission data is received from the transmission data creation processing unit 222, destination information from the transmission data and discriminates a type of a suitable physical interface using the destination information vs. physical interface correspondence table 251.

The respective devices of the mobile phone 209 explained above is realized by memory mediums such as a central processing unit (CPU), a read only memory (ROM) that stores a control program, and the like, and circuit components as existing hardware, although any of them is not shown. Processing for transmitting data as an object to be transmitted from the communication interface portions 221 by the mobile phone 209 arranged as described above will be explained below.

The transmission data creation processing unit 222 is realized by one or a plurality of sets of application software. The user of the mobile phone 209 can create the transmission data by starting up desired application software by manipulating a not shown key switch included in the mobile phone 209 or using application software already started up. For example, the user can create a sentence by starting up e-mail creation software, instructs to transmit the sentence by setting a destination IP address or can instruct calling to a predetermined opponent by starting up phone call software. Further, there is a case in which the transmission data is automatically created by application software and subjected to transmission processing.

FIG. 7 shows an arrangement of the transmission data created by the transmission data creation processing unit. The transmission data 301 is composed of variable-length application data 302 and destination information 303 as information as to a destination to which the application data 302 is transmitted. The destination information 303 is composed of a destination IP address 304 as an IP address allocated to a communication apparatus of the destination and an destination port number 305 as an identifier that shows to which application software the data is to be delivered in the communication apparatus of the destination. The following explanation will be made on the assumption that the transmission data 301, which has the destination IP address 304 set to “192.168.3.220” and the destination port number 305 set to “50”, is newly created by the transmission data creation processing unit 222. When the transmission data creation processing unit 222 creates the transmission data 301, it supplies the transmission data 301 to the transmission data analysis processing unit 225. The physical interface discrimination processing unit 252 of the transmission data analysis processing unit 225 extracts the destination information 303 from the received transmission data 301 and searches the destination information 303 in the destination information vs. physical interface correspondence table 251.

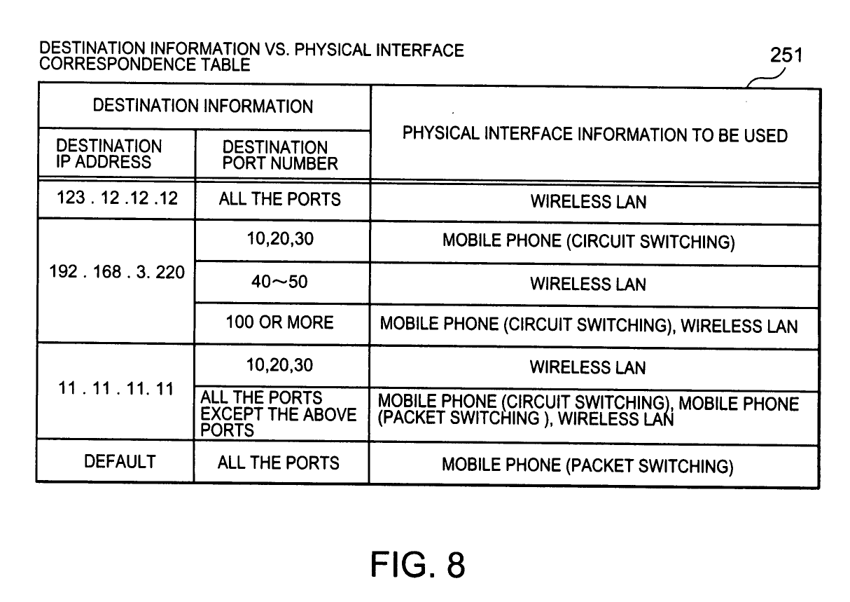

FIG. 8 shows the contents of the destination information vs. physical interface correspondence table 261. The destination information vs. physical interface correspondence table 251 shows the information of a physical interface to be used in transmission in correspondence to each of the respective contents of the destination information that may be added to the transmission data 301. The physical interface discrimination processing unit 252 searches the destination information, to which the destination information 303 described in the received transmission data 301 corresponds, from the destination information described here and obtains the information of a physical interface to be used which corresponds to the searched destination information.

Since the destination information 303 is composed of the destination IP address 304 and the destination port number 305, even if the transmission data 301 has the same destination port number 305 corresponding to the same application software, the physical interface to be used can be changed depending to an opponent. When, for example, the transmission data 301 requests contents to a web server which provides contents mainly composed of text data, any physical interface may be employed. However, when the transmission data 301 requests contents to a server which provides contents including moving picture data, high speed Wireless LAN is preferably employed. Even in this case, a proper physical interface can be selected in correspondence to destination information by registering a physical interface in correspondence to each of the respective patterns of combination of the destination IP addresses 304 and the destination port numbers 305.

In the transmission data 301, since the destination IP address 304 is set to “192.168.3.220” and the destination port number 305 is set to “50”, “Wireless LAN” is obtained as the information of the physical interface to be used. The physical interface discrimination processing unit 252 supplies the obtained information of the physical interface to be used to the path controller 226. On receiving the information of the physical interface to be used, the path control table determination processing unit 243 of the path controller 226 determines a path control table 236 to be used by the IP packet creation/transmission processing unit 237 of the IP protocol processing unit 224.

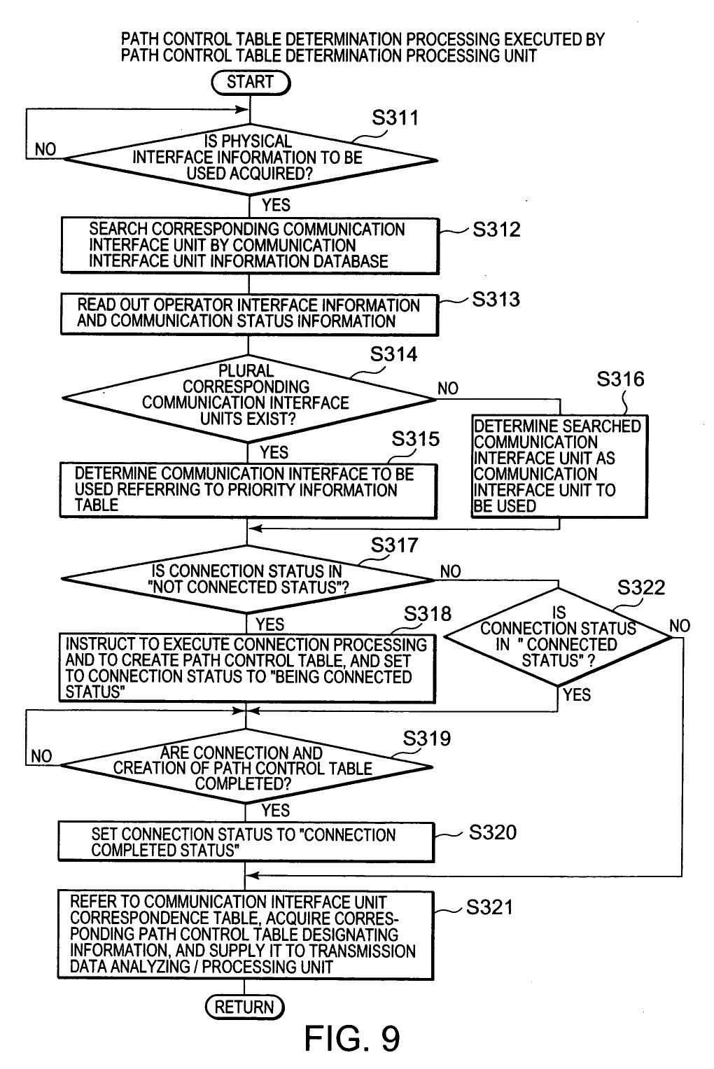

FIG. 9 shows a flow of path control determination processing executed by the path control table determination processing unit. On receiving the information of the physical interface to be used (step S311; Y), the path control table determination processing unit 243 searches a communication interface portion 221 having the physical interface shown by the information of the physical interface to be used from the communication interface portion information database 242 (step S312).

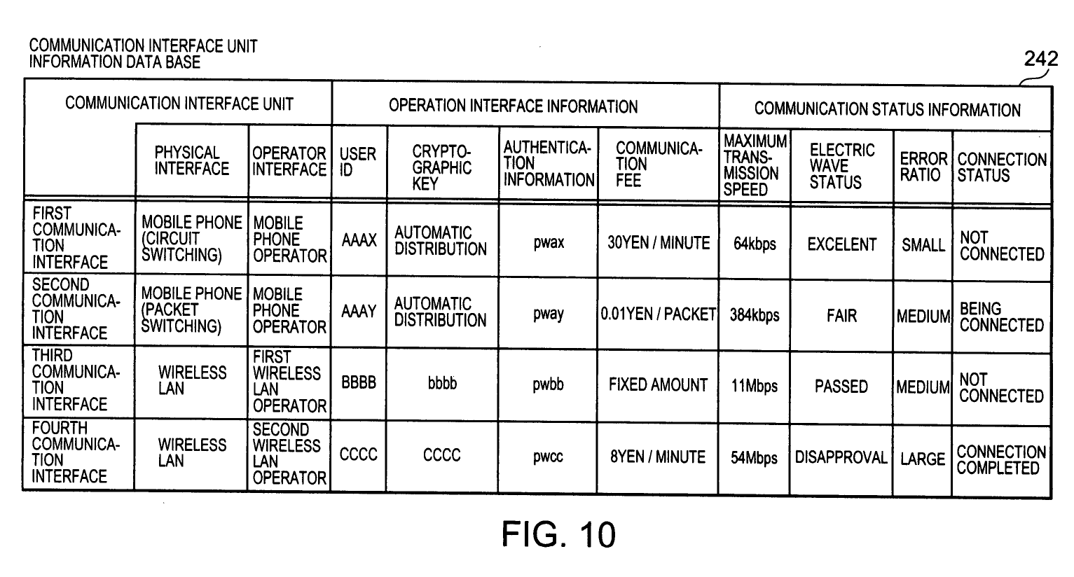

FIG. 10 shows the contents of the communication interface portion information database. The communication interface portion information database 242 describes the physical interfaces and the operator interfaces that constitute the respective communication interface portions 221. The communication interface portion information database 242 stores operator interface information as various types of information, which is necessary to connect to corresponding networks through the respective operator interfaces, in correspondence to each of the respective communication interface portions 221. Further, the communication interface portion information database 242 also stores communication status information showing the communication statuses of the communication interface portions 221 in correspondence to them.

The operator interface information is composed of a user ID used in communication services registered in the communication interface portions 221, a cryptographic key used to get security, authentication information to be transmitted when authentication is executed, and a communication fee. The operator interface information is information which is necessary when a communication interface portion 221 requests a connection to a corresponding network using a device driver and set when sign-up to various communication services is executed. Further, the communication status information is composed of a maximum transmission speed in a communication using the communication interface portions 221, an electric wave status in a wireless communication, a data error ratio in the communication using the communication interface portions 221, end a connection status of the communication interface portions 221 to a corresponding network. The communication interface portion manager 241 of FIG. 5 sequentially monitors the maximum transmission speed, the electric wave status, the error ratio, and the connection status of each of the first to fourth communication interface portions 221₁ to 221₄ and sequentially reflects a result of the monitoring to the communication interface portion information database 242.

Returning to FIG. 9, the path control table determination processing unit 243 reads out the operator interface information and the communication status information corresponding to the respective searched communication interface portions 221 from the communication interface portion information database 242 (step S313). Since the received information of the physical interface to be used is “Wiresless LAN” here, the various types of information corresponding to the third communication interface portion 221₃ and the various types of information corresponding to the fourth communication interface portion 221₄ are read out here. When a plurality of communication interface portions 221 correspond to “Wireless LAN” as described above (step S314: Y), which of the communication interface portions 221 is be employed is determined referring to the priority information table 244 of FIG. 5 (step S315).

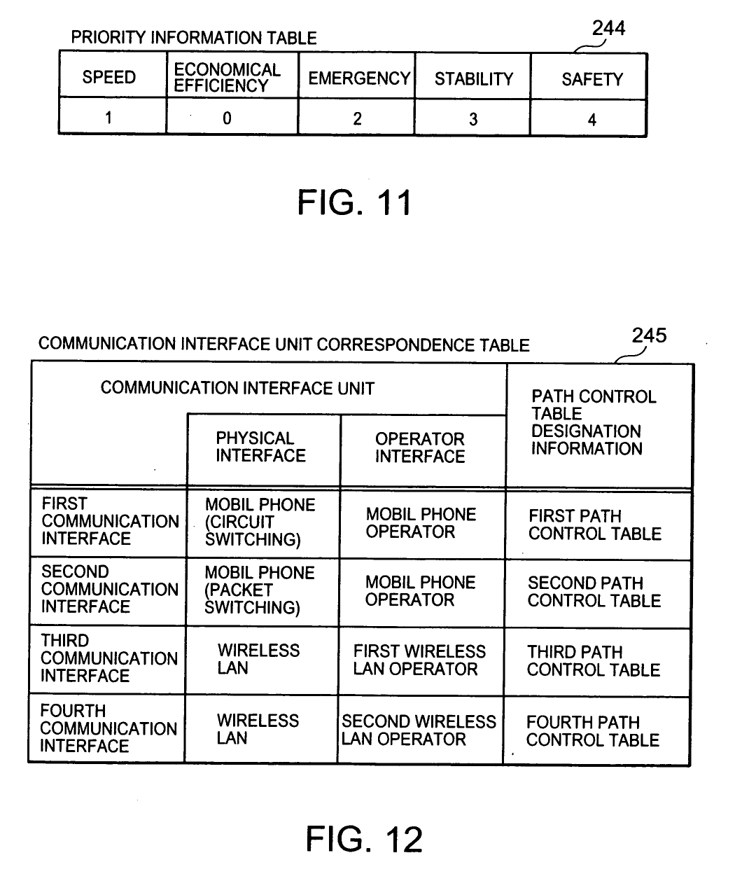

FIG. 11 shows the contents of the priority information table. The priority information table 244 describes numerical values showing the priorities of respective items to be realized as a communication environment that is, information as a basis for selecting a communication interface portion 221 to be used. A minimum value is set to “0” and a smaller numerical value shows a higher priority, and, for example, an item “speed” is set to a numerical value “1”, and an item “economical efficiency” is set to a numerical value “0”. More specifically, items having a smaller numerical value are sequentially employed as the bases of comparison of the respective communication interface portions 221, and when the communication interface portions 221 are narrowed down to one communication interface portion at the time any of the bases of comparison is employed, it is determined as the communication interface portion 221 to be used to a communication. The numerical values of the respective items are preset by manipulating a key switch by the user or by application software for creating transmission data.

The item “economical efficiency”, which is set to the numerical value “0” showing highest priority in the priority information table 244 shown in FIG. 11 corresponds to the communication fee in the information shown in FIG. 10. When the communication fee of the third communication interface portion 221₃ is compared with that of the fourth communication interface portion 221₄, the third communication interface portion 221₃ whose communication fee is fixed regardless a communication time or an amount of communication data has a higher economical efficiency than the fourth communication interface portion 221₄. Accordingly, the third communication interface portion 221₃ is selected. When, for example, the communication fees of both the communication interface portion 221₃ and 221₄ are fixed, since they cannot be narrowed down to one communication interface portion by the comparison basis, they are compared with each other as to the maximum transmission speed corresponding to the item “speed” whose priority is set to a next higher numerical value “1”. In this case, the fourth communication interface portion 221₄ having a higher transmission speed is selected. However, since the electric wave status of the fourth communication interface portion 221₄ is “disapproval”, when it is not improved within a predetermined time, the third communication interface portion 221₃ is used.

Returning to FIG. 9, when only one communication interface portion 221 is detected at step S312 (step S314: N), it is determined to use the communication interface portion 221 (step S216). When the communication interface portion 221 to be used is determined as described above, the connection status of the determined communication interface portion 221 is confirmed in the communication interface portion information database 242 (step S317). When the connection status is “not connected” (Y), the path control table determination processing unit 243 instructs the communication interface portion 221 to execute connection processing as well as instructs the IP protocol processing unit 224 to create the contents a corresponding path control table 236. Further, the corresponding connection status of the communication interface portion information database 242 is rewritten to “being connected” (step S318). Specifically, the execution of the connection processing is instructed to the device driver as the operator interface of the corresponding communication interface portion 221. Then, the user ID, the cryptographic key, and the authentication information is read out from the operator interface information of the corresponding communication interface portion 221 and supplied to the device driver. The device driver of each communication interface portion 221 executes connection processing to a corresponding network using received information, and when the connection is completed, the device driver notifies the communication interface portion manager 241 of it. Further, on the completion of creation of the instructed path control table 236, the IP protocol processing unit 224 also notifies the communication interface portion manager 241 of it. Note that a preset path control table or a path control table created in past connection processing may be used in place of creating the path control table 236 each time the connection processing is executed.

When the completion of connection is notified from the communication interface portions 221 and further the completion of creation of the path control table 236 is notified from the IP protocol processing unit 224 (step S319: Y), the corresponding connection status of the communication interface portion information database 242 is rewritten to “connection completed” (step S320). Further, path control table designation information is obtained referring to the communication interface portion correspondence table 245 as information for designating which one of the first to fourth path control tables 2361 to 2364 is to be used by the IP packet creation/transmission processing unit 237, and the path control table designation information is supplied to the transmission data analysis processing unit 225 of FIG. 2 (step S321). Then, it is waited that the information of the physical interface to be used is supplied from the transmission data analysis processing unit 225 again.

FIG. 12 shows the contents of the communication interface portion correspondence table 245. The communication interface portion correspondence table 245 describes the physical interfaces and the operator interfaces that constitute the respective communication interface portions 221. Then, the communication interface portion correspondence table 245 describes path control table designation information showing any of the first to fourth path control tables 236₁ to 236₄ for each of the communication interface portions 221. For example, a “third path control table” is described as the path control table designation information corresponding to the third communication interface portion 221₃. This shows that the third path control table 236₃ must be used to transmit the transmission data 301 from the third communication interface portion 221₃.

Returning to FIG. 9, when the connecting status is in the “being connected” status (step S317. N, step 322: Y), a process goes to step S319 at which a notification of the completion of connection and the completion of creation of the path control table 236 is waited, and the process goes to processing for determining the path control table 238. When the connecting status is in the “completion of connection” status (step S322: N), the process goes to step S321 for determining the path control table 236.

Here, the third communication interface portion 221₃ is selected at step S315, and the connecting status thereof is in the “not connected” status. Accordingly, the third communication interface portion 221₃ is connected to the first LAN 204, and the third path control table 236₃ is created in the IP protocol processing unit 224. Then, the path control table determination processing unit 243 supplies the “Third path control table” to the transmission data analysis processing unit 225 as path control table designation information based on the communication interface portion correspondence table of FIG. 12. The transmission data analysis processing unit 225 supplies the application data 302, the destination information 303, and the path control table designation information obtained in correspondence to the destination information 303 to the TCP/UDP protocol processing unit 223 as a set of data (hereinafter, appropriately referred to as first data).

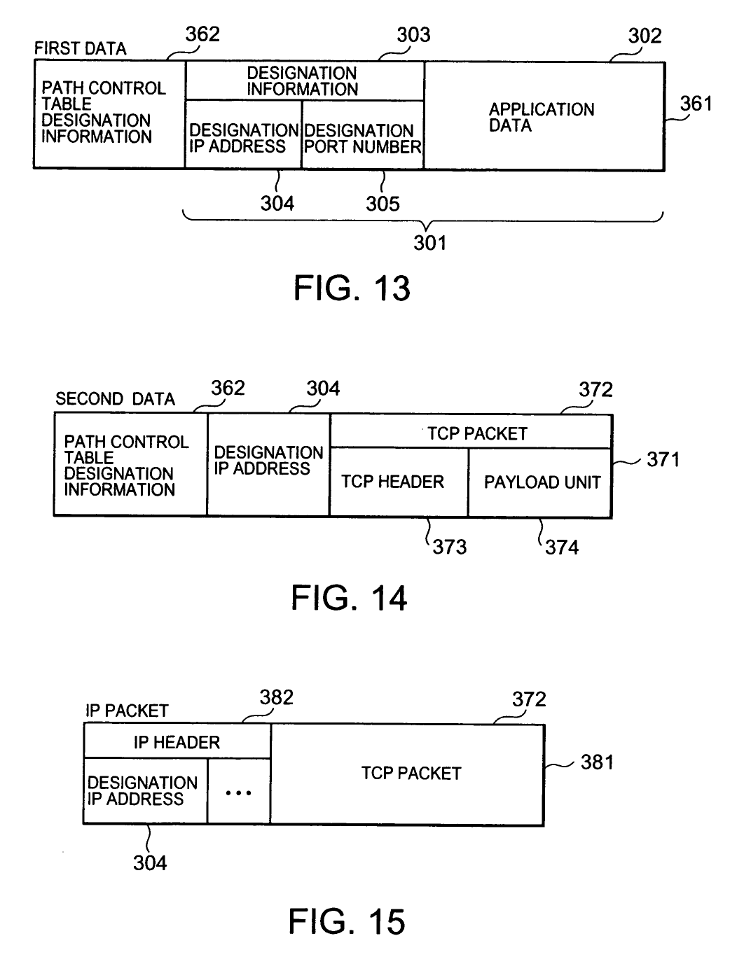

FIG. 13 shows an arrangement of the first data which the TCP/UDP protocol processing unit receives from the transmission data analysis processing unit. The first data 361 is formed by newly adding path control table designation information 362 to the transmission data 301 shown in FIG. 7. The TCP/UDP protocol processing unit 223 discriminates that the first data 361 is to be converted into any ones of the TCP packet and the UDP packet based on the destination port number 305. It is assumed here that it is to be converted into the TCP packet. The TCP/UDP protocol processing unit 223 creates a plurality of TCP packets by dividing the application data 302 to fixed lengths and adding a TCP header describing various types of information including the destination port number 305 to the divided application data 302. Then, the TCP/UDP protocol processing unit 223 supplies the respective created TCP packets, the destination IP address 304, and the path control table designation information 362 to the IP protocol processing unit 224 as a set of data (hereinafter, appropriately referred to as second data).

FIG. 14 shows an arrangement of the second data which the IP protocol processing unit 224 receives from the TCP/UDP protocol processing unit 223. The second data 371 is composed of the path control table designation information 362, the destination IP address 304, and the TCP packets 372. Each of the TCP packets 372 is composed of the TCP header 373 and a payload portion 374 in which any one of the divided portions of the application data 302 of FIG. 13 is stored. On receiving the respective second data sets 371, the IP packet creation/transmission processing unit 237 creates IP packets based on the TCP packets 372 thereof.

FIG. 15 shows an arrangement of the IP packets created by the IP packet creation/transmission processing unit 237. Each of the IP packets 381 is formed by adding an IP header 382 describing various types of information including the destination IP address 304 to the TCP packet 372 of the second data 371 of FIG. 14. The IP packet creation/transmission processing unit 237 first discriminates any of the first to fourth path control tables 236₁ to 236₄ is instructed to be used to determine a next transfer destination of the created IP packet 381.

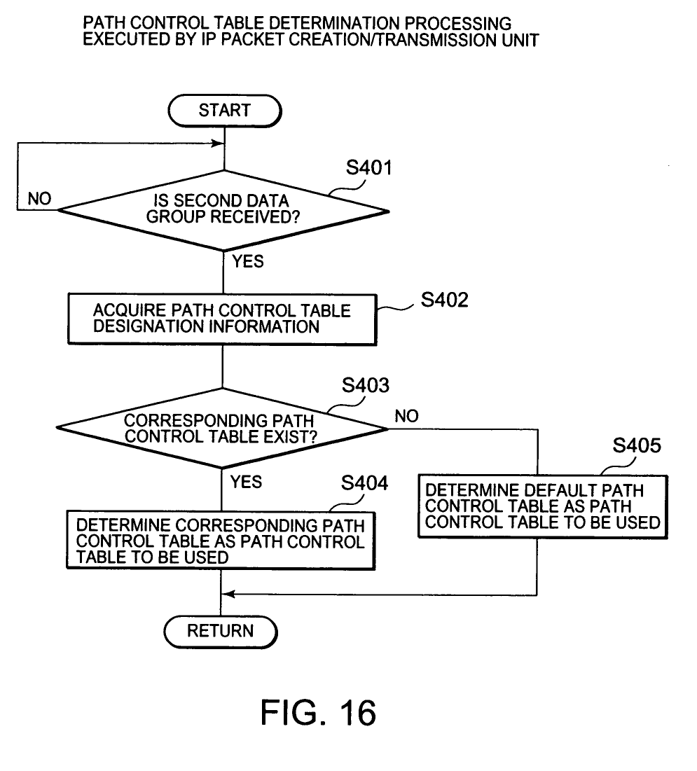

FIG. 16 shows a flow of path control table determination processing executed by the IP packet creation/transmission processing unit 237. On receiving the second data sets 371 from the TCP/UDP protocol processing unit 223 (step S401: Y), the IP packet creation/transmission processing unit 237 receives the path control table designation information 362 of the second data 371 (step: S402). When a corresponding path control table 236 exists in the first to fourth path control tables 236₁ to 236₄ (step S403: Y), the path control table 236 is determined as a path control table which is used in the IP packets 381 created based on the second data 371 received at step S401. When the corresponding path control table 236 does not exist in the received path control table designation information 362 because it is deleted or the creation thereof falls (step S403: N), a default path control table 236 is determined as the path control table to be used (step S405). When the path control table to be used is determined at step S404 or S405, a process returns to step S401 again at which it is waited that the second data 371 is supplied from the TCP/UDP protocol processing unit 223 (return).

Here, since the path control table designation information 362 of the received second data 371 indicates the “third path control table”, the third path control table 236₃ is determined as the path control table to be used.

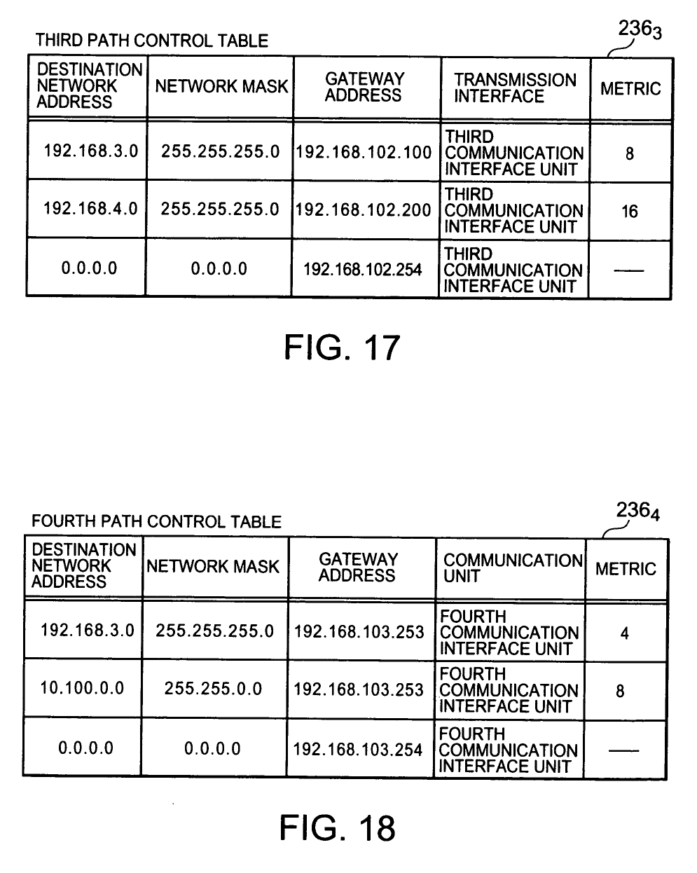

FIG. 17 shows a part of the contents of the third path control table. The third path control table 236₃ describes a destination network address, a network mask, and a gateway address showing a next transfer destination for causing an IP packet to reach the network for each of address networks as networks acting as addresses. The third path control table 236₃ describes a transmission interface which shows a communication interface portion 221 connected on the same subnet as the gateway address, that is, a transmission interface showing the communication interface portion 221 to be used to transmit the IP packet. Further, the third path control table 236₃ describes a metric as a parameter for defining priority when a path is selected. The metric is, for example, the number of hops as the number of routers existing on a path up to the address network, the transmission speed of a path, or a composite metric obtained by combining a plurality of metric. Note that although a multicast address and the like for making transmission to all the communication devices belonging to the same subnet are actually set to the third path control table 236₃, in addition to the above-mentioned, the illustration and explanation thereof is omitted.

Combinations of the destination network addresses and the network masks show the ranges of the IP addresses allocated to a corresponding network. Accordingly, a transmission interface and a gateway address for transmitting the IP packet 381 shown in FIG. 15 can be specified by discriminating the range, to which the destination IP address 304 belongs, of the ranges of the respective IP addresses shown by the destination network addresses and the network masks. As apparent from the figure, discrimination of coincidence with the destination network address shows that all the interfaces are the “third communication interface portions”.

Further, when the path control table designation information 362 of the received second data 371 is a “fourth path control table portion”, the fourth path control table 236₄ is determined as the path control table to be used by the path control table determination processing of FIG. 16.

FIG. 18 shows a part of the contents of the fourth path control table. The fourth path control table 236₄ also describes a gateway, a transmission interface, and a metric to each of networks acting as addresses likewise the third path control table 236₃ shown in FIG. 17. However, it is different from the third path control table 236₃ that the all the transmission interfaces of the fourth path control table 236₄ are “fourth communication interfaces”. Further, although not shown, all the communication interfaces in the first path control table 236₁ are “first communication interfaces” likewise, and all the communication interfaces in the second path control table 236₂ are also “second communication interfaces”.

These first to fourth path control tables 236₁ to 236₄ are created by an instruction from the path controller 228. As explained already, when the connecting status of the communication interface portions 221, which has determined to use the transmission of the transmission data 301, is in the “not connected” status, the path controller 226 instructs the IP protocol processing unit 224 to create a corresponding path control table 236. On the completion of the connection of the corresponding communication interface portions 221, the IP protocol processing unit 224 creates the path control table 236 which uses only the communication interface portions 221 as a transmission interface. The gateway address of a default route is set based on the information received from a connection opponent by Point to Point Protocol (PPP) and Dynamic Host Configuration Protocol (DHCP), and the other destinations are set based on the information obtained by a protocol for exchanging predetermined routing information. When an arrangement of the communication system 200 of FIG. 1 changes, the contents of the created path control table 236 are also appropriately updated based on the switched routing information. Otherwise, the contents may be set based on information such as a configuration file and the like previously stored in the mobile phone 209.

When the new path control table 236 is created as described above, the IP protocol processing unit 224 individually sets information for identification such as, for example, the “third path control table” and the like and returns the information to the path controller 226. The path control table determination processing unit 243 receives the information returned to it through the communication interface portion manager 241 and registers the information to the communication interface portion correspondence table 245 of FIG. 12 as path control table designation information in correspondence to the communication interface portion 221 which triggered the creation of the communication interface portion correspondence table 245. With the above operation, the path control table designation information is stored in the communication interface portion correspondence table 245 in correct correspondence, thereby a path control table to be used can be properly determined.

When the path control table to be used is determined by the path control table determination processing of FIG. 16, a next transfer destination of the corresponding IP packets 381 is determined using the path control table to be used, and transmission is executed using the communication interface portion 221 connected to the thus determined next transfer destination.

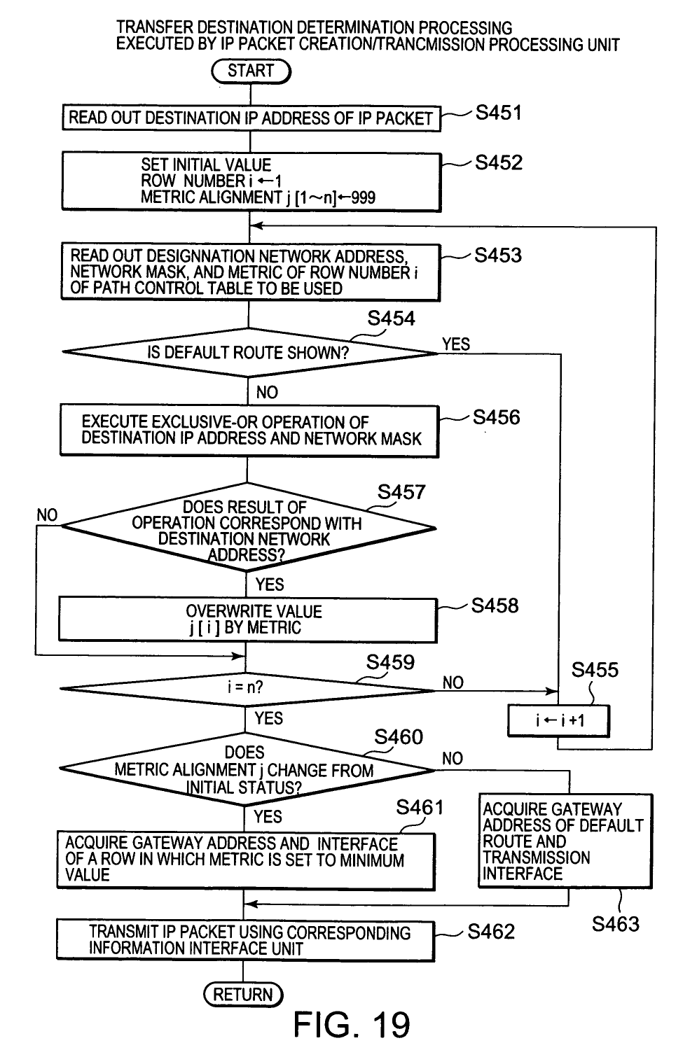

FIG. 19 shows a flow of transfer destination determination processing executed by the IP packet creation/transmission processing unit. When the path control table to be used is composed of the number of rows n, the IP packet creation/transmission processing unit 237 prepares a row number i indicating the number of a row to be processed of the path control table to be used and a metric alignment j composed of n pieces of parameters for storing the metrics of the respective rows as variables. The destination IP address 304 of the IP packet 381 whose path control table to be used is determined by the path control table determination processing of FIG. 16 is read out (step S451). A numerical value “1” is set to the row number i as an initial value, and a numeric value “999” is set to all the parameters corresponding to the respective rows of the metric alignment j (step S452). The numerical value “999” is set in correspondence to that a smaller metric value corresponds to a higher priority, and the value “999” is larger than a maximum value set as the metric. With this arrangement, a candidate having a smallest metric value can be easily searched from candidates selected as the transfer destinations of the IP packets 381 by processing described below.

Next, the destination network address, the network mask, and the metric of the row number i of the path control table 236 determined as the path control table to be used are read out (step S453), and whether or not they show the default route is first determined (step S454). Specifically, this is determined by whether or not the destination IP address is set to “0.0.0.0”. When they show the default route (Y), the numerical value of the row number i is incremented by 1 (step S455), and a process returns to step S453 and shifts to processing of a next row.

When they do not show the default route (step S454: N), an exclusive-or operation is executed to the destination IP address 304 of the IP packets 381 and the network mask of the row number i (step S456). When a result of the operation agrees with the destination network address of the row number i (step 457: Y), the parameter corresponding to the row number i of the metric alignment j set to the initial value “999” is overwritten by the metric of the row number i (step S458). When the processing does not reach a final row, that is, when the row number i does not agree with the number of rows n of the path control table to be used (step S459: N), the process goes to step S455 at which the numerical value of the row number i is incremented by 1 and returns to step S453 and shifts to processing of a next row. When the result of the exclusive-or operation does not agree with the destination network address of the row number i (step S457: N), since the transfer destination shown by the row does not correspond to the transfer destination of the IP packet 381, the process goes to step S459 without storing a metric in the metric alignment j.

The respective rows are sequentially processed from a first row by repeating step S453 to step S459. When the processing reaches the final row (step S459: Y), whether or not information as to the destination network, to which the address of the IP packets 381 belongs, exist is determined based on whether or not the metric alignment j changes from an initial status (step S460). When parameters, which change from an initial value, exist (step S460: Y), information showing a next transfer destination of the IP packets 381 is described in the row number i corresponding to the parameters. Accordingly, the row number of the parameter having a minimum value as the metric is specified from the parameters which have changed from the initial value, and the gateway address and the transmission interface of a corresponding row number is obtained from the path control table to be used (step S461).

Then, the IP packets 381 is transmitted using the corresponding communication interface portion of the first to fourth communication interface portions 221₁ to 221₄ (step S462), and the processing is finished (end). Specifically, the IP packets 361 is input to a not shown input terminal included in the corresponding communication interface portion 221. Then, the communication interface portion 221 is caused to create an ether frame having a destination, which set to an MAC address corresponding to the gateway address obtained at step S401, and the IP packet 381 as a payload, and the ether frame is transmitted from an antenna as a not shown output terminal through a wireless signal.

When the metric alignment j remains in the initial status, that is, when information as to the destination network to which the destination of the IP packets 381 belongs does not particularly exists (step S460: N), the gateway address of the default route and the transmission interface are obtained (step S463). Then, the IP packet 381 is transmitted using the corresponding communication interface portion 221 likewise (step S461), and the processing is ended (END).

The destination IP address 304 of the IP packets 381 is set to “192.168.3.220” here, and the third path control able 236₃ shown in FIG. 17 is determined as the path control table to be used. That is, in the third path control table 236₃, the row in which the destination network “192.168.3.0” and the network mask “255.255.255.0” are described corresponds to the path control table to be used. Accordingly, the “third communication interface portion” as the transmission interface and the gateway address “192.168.102.100” are obtained at step S461 of FIG. 19, and transmission is executed using the third communication interface portion 221₃. Since the physical interface is Wireless LAN and the operator interface is the first Wireless LAN operator as shown in FIG. 3, the third communication interface portion 221₃ is connected to the first LAN 204 through the third Wireless Base Transceiver Station 208 of FIG. 1.

In contrast, when the fourth path control table 2364 shown in FIG. 18 is determined as the path control table to be used, the “fourth communication interface portion” as the transmission interface and the gateway address “192.168.103.253” are obtained at step S461. Accordingly, transmission is executed using the fourth communication interface portion 221₄ likewise. Since the physical interface is Wireless LAN and the operator interface is the second Wireless LAN operator as shown in FIG. 3, the fourth communication interface portion 221₄ is connected to the second LAN 205 through the third Wireless Base Transceiver Station 208 of FIG. 1.

When the corresponding metrics are compared with each other at the time the destination IP address 304 is “192.168.3.220” in the third and fourth path control tables 236₃ and 236₄, the numerical value of the metric is “8” in the third path control table 236₃, and the numerical value of the metric is “4” in the fourth path control table 236₄. Accordingly, when one common path control table is prepared without dividing it for respective transmission interfaces, the gateway address, which uses the “fourth communication interface portion” whose metric has the smaller value, is employed as the transmission interface. As a result, the third communication interface portion 2213 cannot be used, which makes it impossible to reflect the request of a user who desires to execute transmission at lower cost and a request for the transmission environment of application software.

In the embodiment, a path control table 236 using only a communication interface portion 221 is prepared for each of the communication interface portions 221, and a path is determined using a path control table corresponding to the communication interface portion 221 which is determined suitable to the contents of a request. With this arrangement, even transmission data 301 having the same destination IP address 304 can be transmitted by simply selecting a proper communication interface from the plurality of communication interfaces and using the selected communication interface. Note that, on the completion all the application software sets, the path controller 226 indicates to disconnect the respective communication interface portions 221 being connected as well as indicates the IP protocol processing unit 224 to delete the created path control table 236.

As to the arrangement of the plurality of communication interface portions, various patterns are contemplated in addition to those shown in FIG. 3.

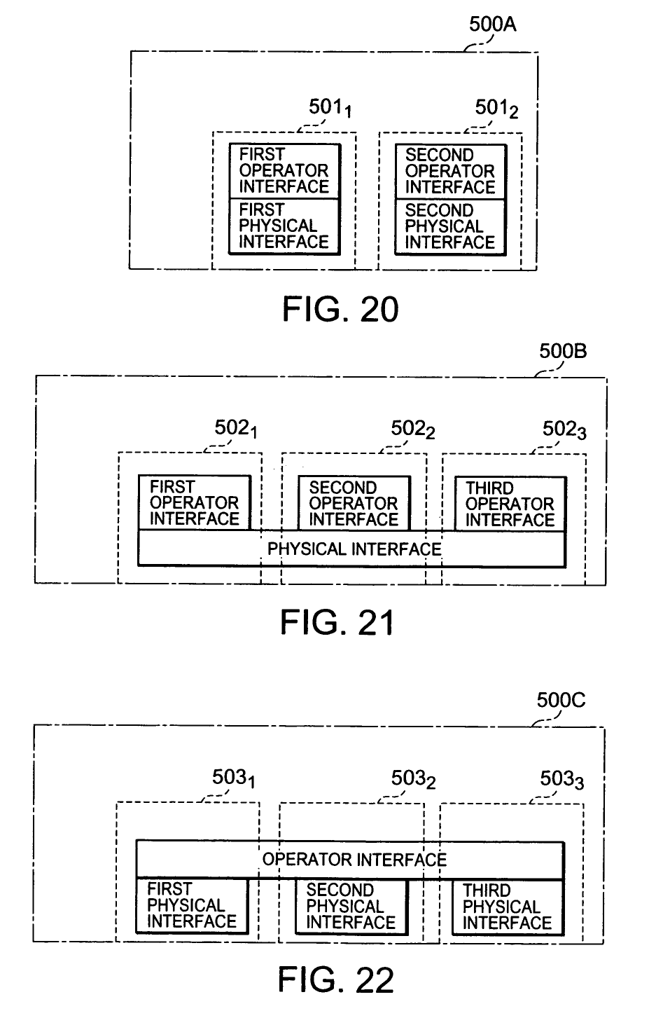

FIG. 20 schematically shows a first example of the other patterns of the plurality of communication interface portions. Each of first and second communication interface portions 501₁ and 501₂ disposed to a mobile phone 500A is composed of a different operator interface and a different physical interface. When communication interface portions have only the two communication interface portions, that is, the second communication interface portion 221₂ and the third communication interface portion 221₃ of the communication interface portions 221 shown FIG. 3, they have the arrangement as shown in FIG. 20.

FIG. 21 schematically shows a second example of the other patterns of the plurality of communication interface portions. Each of firs to third communication interface portions 502₁ to 501₃ disposed to a mobile phone 500B is composed of a different operator interface and a common physical interface. The above arrangement is employed when, for example, there exist first to third Wireless LAN spot operators which provide Wireless LAN spots making use of Wireless LAN by IEEE802.11b and the users of mobile phones join the respective communication services.

FIG. 22 schematically shows a third example of the other patterns of the plurality of communication interface portions. Each of first to third communication interface portions 503₁ to 503₃ disposed to a mobile phone 500C is composed of a common operator interface and a different physical interface. The above arrangement is employed when, for example, there exists a Wireless LAN spot operator which provides a Wireless LAN spot where all of Wireless LANs by IEEE802.11a, IEEE802.11b, and IEEE802.11g can be used and the users of mobile phones join the communication service.

In the embodiment, since the physical interface and the operator interface can be independently defined, any of the above patterns can be applied to the embodiment. Accordingly, transmission can be executed using a communication interface portion composed of a proper physical interface and a proper operator interface. Further, since path control table designation information is sent to the IP protocol processing unit together with respective transmission data sets, a path control table to be used can be easily switched at proper timing, thereby the respective data sets can be transmitted from a proper communication interface portion.

Further, since a communication interface portion can be selected not only based on static information such as a path selection table and a communication fee but also based on dynamic information such as a destination port number, a communication fee, an electric wave status, and the like, a change of a communication status due to the movement of a communication terminal and the like can be easily coped with. Further, the procedures of a TCP protocol and an IP protocol are mounted as ever, the arrangement of the embodiment is advantageous in compatibility with other TCP/IP corresponding apparatuses and possibility of diverting a production line of conventional product, and the like.

<Modification of the Present Invention>

In the embodiment explained above, the path controller creates the path control table designation information using the communication interface portion correspondence table and the priority information table based on the information of the physical interface to be use received from the transmission data analysis processing unit. However, as other method, it is also possible to store numerical values, which show the priorities of items to be realized as a communication environment. In the transmission data analysis processing unit in correspondence to destination information and to send the numerical values to the path controller. Further, in the embodiment, the path control table designation information is determined from the path controller as the respective transmission data sets. However, it is also possible to cache the path control table designation information in the transmission data analysis processing unit in consideration of a case in which transmission data having the same destination information is frequently created.

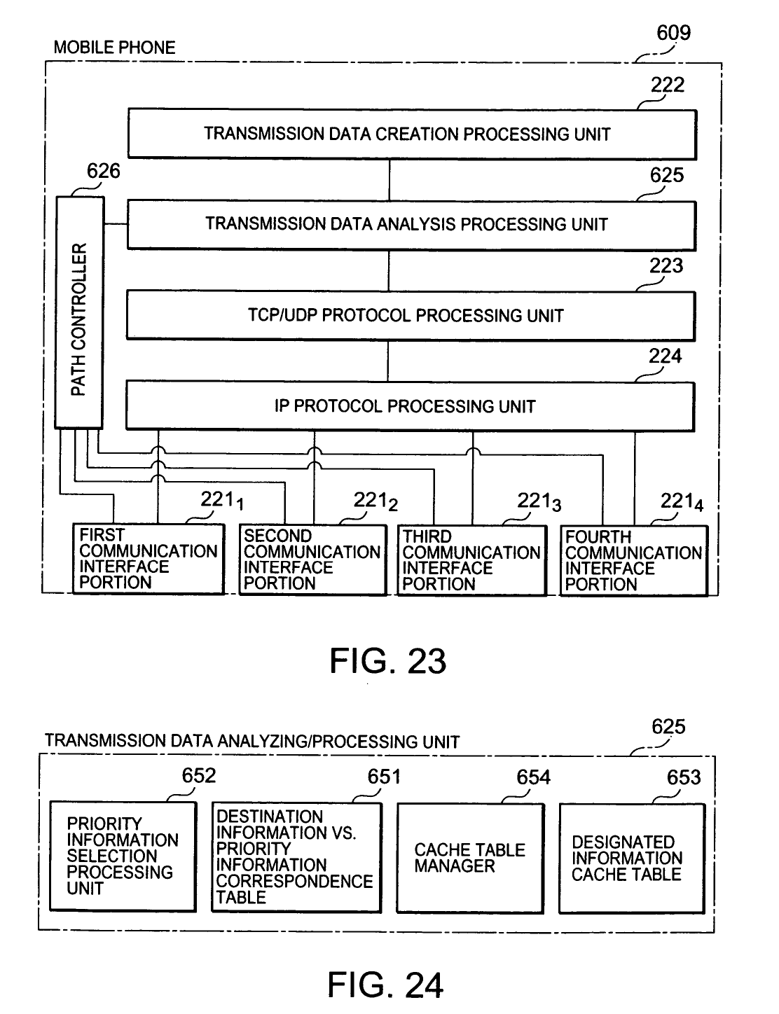

FIG. 23 shows an arrangement of a mobile phone according to the modification. In FIG. 23, the same components as those in FIG. 2 are denoted by the same reference numeral, and the explanation thereof is omitted. The mobile phone 609 has a transmission data analysis processing unit 625 and a path controller 626 in place of the transmission data analysis processing unit 225 and the path controller 228 of FIG. 2.

FIG. 24 shows an arrangement of the transmission data analysis processing unit 825 and corresponds to FIG. 6 of the above embodiment. The transmission data analysis processing unit 625 has a destination information vs. priority information correspondence table 651 and a priority information selection processing unit 652 in place of the destination information vs. physical interface correspondence table 251 and the physical interface discrimination processing unit 252. Further, the transmission data analysis processing unit 626 has a designated information cache table 653 and a cache table manager 654 newly provided therewith. The designated information cache table 653 temporarily stores path control table designation information received from the path controller 626 in corresponding designation information, and the cache table manager 664 manages the designated information cache table 663.

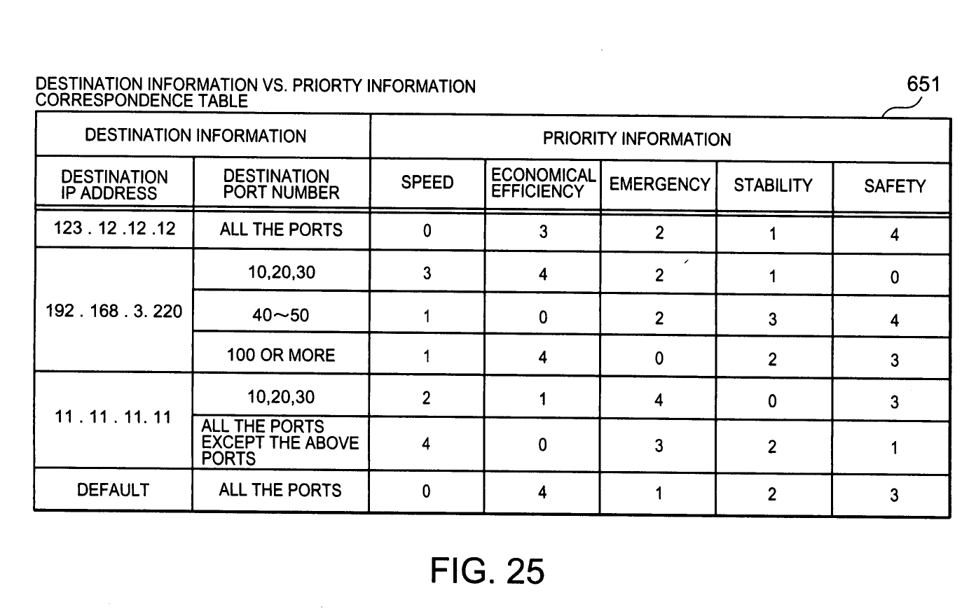

FIG. 25 shows the contents of the destination information priority correspondence table: The destination information vs. priority information correspondence table 651 describes information of each of the contents of destination information that may be added to transmission data 301 likewise the destination information vs. physical interface correspondence table 251 shown in FIG. 8 of the embodiment. However, the destination information priority correspondence table 651 describes priority information showing the priorities of the respective items to be realized as the communication environment in place of the information of the physical interface to be used. Numerical values, which show the priorities of the respective items to be realized as the communication environment, are described in respective priority information sets likewise the priority information table 244 shown in FIG. 11 of the embodiment, and a minimum value is set to “0” and a smaller value shows a higher priority. The numerical values of the respective items are preset by manipulating a not shown key switch by a user or by application software for creating transmission data.

The priority information selection processing unit 652 of FIG. 24 searches the destination information, to which destination information 303 described in the received transmission data 301 corresponds, of the destination information described in the destination information vs. priority information correspondence table 651 and obtains priority information corresponding to it. When it is assumed that the destination IP address 304 of the transmission data 301 is set to “192.168.3.220” and the destination port number 305 thereof is set to “50” likewise the embodiment, priority information in which speed is set to a numerical value “1”, economical efficiency is set to a numerical value “0”, emergency is set to a numerical value “2”, stability is set to a numerical value “3”, safety is set to a numerical value “4” is obtained. The priority information selection processing unit 652 supplies the obtained priority information to the path controller 626.

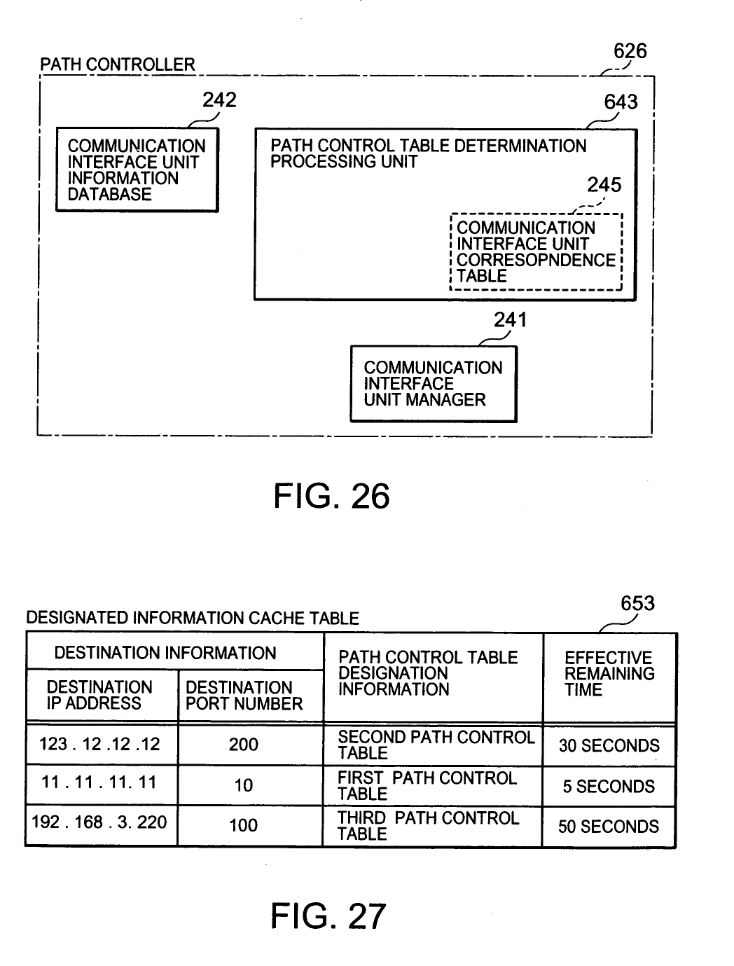

FIG. 26 shows an arrangement of the path controller of FIG. 23 and corresponds to FIG. 5 of the embodiment. In FIG. 26, the same components as those in FIG. 5 are denoted by the same reference numerals, and the explanation thereof is omitted. The path controller 626 has a path control table determination processing unit 643 in place of the path control table determination processing unit 243 of FIG. 5. Further, since the priority information is received from the transmission data analysis processing unit 625, the path control table determination processing unit 643 is not provided with the priority information table 244.

On receiving the priority information from the transmission data analysis processing unit 625 of FIG. 23, the path control table determination processing unit 643 specifies a communication interface portion 221 suitable for the priority information referring to a communication interface portion information database 242. More specifically, items having a smaller numerical value are sequentially employed as the bases of comparison of the respective communication interface portions 221, and when the communication interface portions 221 are narrowed down to one communication interface portion at the time any of the bases of comparison is employed, it is determined as the communication interface portion 221 to be used to a communication.

The item “economical efficiency” having the smallest numerical value in FIG. 25 corresponds to the communication fee in the information shown in FIG. 10. When the communication fees of the respective communication interface portions 221 are compared with each other, the third communication interface portion 2213 whose communication fee is set to a “fixed amount” has a highest economical efficiency. Accordingly, the third communication interface portion 221₃ is selected. When the communication interface portions 221 to be used is selected as described above, which of first to fourth path control tables 236₁ to 236₄ is to be used is determined referring to the communication interface portion correspondence table 245 likewise the embodiment. Then, the path control table designation information is created and supplied to the transmission data analysis processing unit 625.

On receiving the path control table designation information from the path controller 626, the cache table manager 654 of the transmission data analysis processing unit 625 shown in FIG. 24 registers the destination information 303 of the corresponding transmission data 301 and the path control table designation information thereof to the designated information cache table 653 in correspondence to each other.

FIG. 27 shows the contents of the designated information cache table. The designated information cache table 653 set effective remaining times to the destination information and the path control table designation information that are registered by the cache table manager 654 to show the remaining lengths of the times during which the information is effective. When the transmission data 301 having the same destination information 303 is frequently created, processing for transmitting the same priority information a number of times and receiving the same result is repeated. To cope with this problem, the cache table manager 654 causes the designated information cache table 653 to hold the path control table designation information received from the path controller 626 as a pair of the information and the destination information 303 within the range of a given length of time set previously. When the destination information 303 of the transmission data 301 received from a transmission data creation processing unit 222 exists in the designated information cache table 653, the path control table designation information is obtained from the designated information cache table 653 without using the path controller 626.

When the given lengths of the times are set first, the effective remaining times are periodically updated using a not shown counter. When the effective remaining time of any one of entries is set to a numerical value “0”, the cache table manager 654 deletes the entry. On receiving the transmission data 301 from the transmission data creation processing unit 222, the transmission data analysis processing unit 625 first searches an entry which agrees with the destination information 303 in the cache table manager 654. When there is an entry that agrees therewith, the transmission data analysis processing unit 625 obtains corresponding path control table designation information and supplies it to a TCP/UDP protocol processing unit 223 together with the transmission data 301 as the first data 381 shown in FIG. 13 of the embodiment. With this operation, a processing procedure until the path control table designation information is added to the transmission data 301 is simplified, thereby a speed is increased and a load applied on the apparatus can be reduced. Further, when there is no entry that agrees with the destination information 303, the path control table designation information is obtained by executing the processing by the priority information selection processing unit 662 described above and supplied to the TCP/UDP protocol processing unit 223 together with the transmission data 301 likewise. Processings executed thereafter are the same as those of the above embodiment.

Note that the communication system described above can be variously modified. For example, the transmission data analysis processing unit of the mobile phone of the embodiment may be provided with the designated information cache table and the cache table manager. Further, although the information of the physical interface to be used of the embodiment and the priority information of the modification are determined in correspondence to the destination port address and the destination port number, they may be determined in correspondence to any one of them or to other various types of information. Further, the information of the physical interface to be used and the priority information may be stored in the path control table determination processing unit of the path controller as previously fixed contents, and it contemplated to use a path control table corresponding to a communication interface portion having a best electric wave status as the path control table designation information referring only to, for example, the electric wave status. The path control table designation information may be formed by application software or by the manipulation of the user, or path control table designation information created once may be temporary stored in the IP protocol processing unit and used continuously.

Further, the transmission data and the path control table designation information may be held in correspondence to each other by using an identifier or by adjusting the timings of various processings executed in various processing units and may be supplied to the IP protocol processing unit through a different path. Further, it is also possible to supply the information of the physical information to be used and the priority information to the path controller after they are converted into date lower then a transport layer of the TCP packet and the like. Further, the physical interface discrimination processing unit and the destination information vs. physical interface correspondence table of the embodiment and the priority information selection processing unit and the destination information vs. priority information correspondence table, the cache table manager, and the designated information cache table of the modification may be disposed to the path controller. In this case, the transmission data analysis processing unit supplies the destination information of the transmission data received from the transmission data analysis processing unit to the path controller.

Further, in the embodiment and the modification described above, the physical interface is described as a communication device for realizing the mobile phone and as a communication device for realizing Wireless LAN by the mobile phone. However, it is needless to say that the physical interface can be applied to a communication device applied to various types of wireless and fixed-line transmission mediums and communication mediums. For example, an Ethernet (registered trademark) card and a Wireless LAN card are exemplified. Further, the embodiment and the modification can be also applied to a case in which, although, for example, Wireless LANs each having a different standard are provided as the physical interfaces, the physical interfaces are partly overlapped so that the output terminals of the respective physical interfaces connected to a common antenna can be shared. Further, it is needless to say that the embodiment and the modification can be applied to the other various types of data transmission apparatuses. Otherwise, when a recording medium for recording a program, which is executed by a CPU for realizing respective devices, is arranged as a recording medium which can be detachably mounted and can be mechanically read, it is needless to say that the embodiment and the modification may mount the recording medium on a general-purpose data transmission apparatus when necessary.

What is claimed is:

1. A data transmission apparatus, comprising:
a plurality of sets of communication network connection means for connecting to different communication networks, respectively;
communication quality information store means for storing communication quality information as information as to the communication quality of the communication networks, to which the respective sets of the communication network connection means are connected, by corresponding the communication quality information to each of the plurality of sets of communication network connection means;
a plurality of address path correspondence tables each disposed to each of the transmission network connection means to store the addresses of respective opponents and path information as information showing paths to the addresses through the communication networks, to which the transmission network connection means are connected, by corresponding the addresses to the path information;
to-be-used communication network connection means selection means for selecting communication network connection means which is used to transmit data as the object of transmission based on the communication quality information stored in the communication quality information store means;
address path correspondence table discrimination means for discriminating an address path correspondence table corresponding to the communication network connection means selected by the to-be-used communication network connection means selection means from the plurality of address path correspondence tables;
path information acquisition mean for acquiring corresponding path information by searching the destination address of the data by the address path correspondence table discriminated by the address path correspondence table determination means; and
data transmission means for transmitting the data through the path shown by the path information acquired by the path information acquisition means.

2. A data transmission apparatus according to claim 1, further comprising:
communication status monitor means for sequentially monitoring the communication status of each of the plurality of communication networks; and
communication quality information change means for sequentially changing the corresponding contents of the communication quality information stored in the communication quality information store means according to a result of the monitor executed by the communication status monitor means.

3. A data transmission apparatus according to claim 1, wherein the to-be-used communication network connection means selection means is means comprising requested quality discrimination means for discriminating requested quality as communication quality requested to transmission of data as an object of transmission and requested quality suitability discrimination means for discriminating the communication quality information which is most suitable to the requested quality discriminated by the requested quality discrimination means in the communication quality information stored in the communication quality information store means and selecting corresponding communication network connection means as communication network connection means to be used for the transmission of the data.

4. A data transmission apparatus according to claim 1, further comprising communication quality of respective sets of application store means for storing application information for identifying a plurality of sets of different application software and communication quality of respective sets of application as communication quality suitable to the respective sets of the application software by corresponding the application information to the communication quality of the respective sets of the application,
wherein the to-be-used communication network connection means selection means comprises communication quality of respective sets of application acquisition means for searching the application information of application software using data added to the data as the object of the transmission in the communication quality of respective sets of application store means and acquiring corresponding communication quality of the respective sets of application and suitability of communication quality of respective sets of application discrimination means for discriminating the communication quality information, which is most suitable to the communication quality of the respective sets of application acquired by the communication quality of respective sets of application acquisition means, from the communication quality information stored in the communication quality information store means and selecting corresponding communication network connection means as communication network connection means to be used to the transmission of the data.

5. A data transmission apparatus according to claim 1, further comprising communication quality of respective opponents store means for storing the addresses of respective opponents and communication quality of the respective opponents as communication quality suitable to a communication to the respective opponents by corresponding the addresses to the communication quality of the respective opponents,
wherein the to-be-used communication network connection means selection means is means comprising communication quality of respective opponents acquisition means for searching the destination address of data as an object of transmission by the communication quality of respective opponents acquisition means and acquiring corresponding communication quality of the respective opponents and suitability of communication quality of respective opponents discrimination means for discriminating the communication quality information, which is most suitable to the communication quality of the respective opponents acquired by the communication quality of respective opponents acquisition means, from the communication quality information stored in the communication quality information store means and selecting corresponding communication network connection means as communication network connection means used to the transmission of the data.

6. A data transmission apparatus according to claim 1, wherein the plurality of address path correspondence tables, the path information acquisition means, and the data transmission means correspond to the Internet Protocol.

7. A method of establishing connection between a wireless terminal and a destination terminal, the wireless terminal being connectable to at least two communication networks each of which is connected to an internet, the destination terminal being connected to the internet, comprising the steps of:
(a) selecting one of the communication networks at the wireless terminal based on communication quality of the communication networks;
(b) selecting a path through the communication network and the internet selected at the step (a) at the wireless terminal based on the network address of the destination terminal; and (c) establishing a connection between the wireless terminal and the destination terminal through the path selected at the step (b).

8. A data transmission method comprising:
a requested quality discrimination step of discriminating requested quality as communication quality requested to the transmission of data intended to be transmitted using a plurality of sets of communication network connection means for connecting to different communication networks, respectively;
a communication network connection means selection step of discriminating communication quality information, which is most suitable to the requested quality discriminated at the requested quality discrimination step, as information as to the communication quality of the communication networks to which the plurality of sets of communication network connection means are connected from communication quality information store means in which the communication quality information is stored in correspondence to each of the respective sets of communication network connection means and selecting a corresponding communication network connection means as communication network connection means to be used to the transmission of the data;
an address path correspondence table discrimination step of discriminating an address path correspondence table, which corresponds to the communication network connection means selected at the communication network connection means selection step from a plurality of address path correspondence tables which are disposed to the respective sets of the communication network connection means and in which opponent addresses and path information as information showing paths up to the addresses through communication networks, to which the communication network connection means are connected, are stored in correspondence to each other;
a path information acquisition step of searching the destination address of the data as an object of transmission in the address path correspondence table discriminated at the address path correspondence table discrimination step and acquiring corresponding path information; and
data transmission step of transmitting the data through the path shown by the path information acquired at the path information acquisition step.

9. A data transmission program for causing a computer of a data transmission apparatus to execute:
requested quality discrimination processing for discriminating requested quality as communication quality requested to the transmission of data which the data transmission apparatus intends to transmit using a plurality of sets of communication network connection means for connecting to different communication networks, respectively;
communication network connection means selection processing for discriminating communication quality information, which is most suitable to the requested quality discriminated by the requested quality discrimination processing, as information as to the communication quality of the communication networks to which the plurality of sets of communication network connection means are connected from communication quality information store means in which the communication quality information is stored in correspondence to each of the respective sets of the communication network connection means and selecting a corresponding communication network connection means as communication network connection means to be used to the transmission of the data;
address path correspondence table discrimination processing for discriminating an address path correspondence table, which corresponds to the communication network connection means selected by the communication network connection means selection processing from a plurality of address path correspondence tables which are disposed to the respective sets of the communication network connection means and in which opponent addressee and path information as information showing paths up to the addresses through communication networks to which the communication network connection means are connected;
path information acquisition processing for searching the destination address of the data as an object of transmission in the address path correspondence table discriminated by the address path correspondence table discrimination processing and acquiring corresponding path information; and
data transmission processing for transmitting the data through the path shown by the path information acquired by the path information acquisition processing.

10. A machine language readable recording medium for recording a program for executing a requested quality discrimination procedure for discriminating requested quality as communication quality requested to the transmission of data intended to be transmitted using a plurality of sets of communication network connection means for connecting to different communication networks, respectively;
a communication network connection means selection procedure for discriminating communication quality information, which is most suitable to the requested quality discriminated by the requested quality discrimination procedure, as information as to the communication quality of the communication networks to which the plurality of sets of communication network connection means are connected from communication quality information store means in which the communication quality information is stored in correspondence to each of the respective sets of communication network connection means and selecting a corresponding communication network connection means as communication network connection means to be used to the transmission of the data;
an address path correspondence table discrimination procedure for discriminating an address path correspondence table, which corresponds to the communication network connection means selected by the communication network connection means selection procedure from a plurality of address path correspondence tables which are disposed to the respective sets of the communication network connection means and in which opponent addresses and path information as information showing paths up to the addresses through communication networks to which the communication network connection means are connected;
a path information acquisition procedure for searching the destination address of the data as an object of transmission in the address path correspondence table discriminated by the address path correspondence table discrimination procedure and acquiring corresponding path information; and
a data transmission procedure for transmitting the data through the path shown by the path information acquired by the path information acquisition procedure.
